(19) United States
(12) Patent Application Publication
(10) Pub. No.: US 2007/0050255 A1
(43) Pub. Date: Mar. 1, 2007

(54) System, method, and computer program product for allowing access to a promotion

(75) Inventors: Christopher Hobbs, New York, NY (US); Maura E. Rose, New York, NY (US); Wayne G. Blum, New York, NY (US); Kevin T. Burkhart, Brooklyn, NY (US); Liuliu L. Lu, Tuckahoe, NY (US)

Correspondence Address: STERNE, KESSLER, GOLDSTEIN & FOX PLLC, 1100 NEW YORK AVENUE, N.W., WASHINGTON, DC, 20005, US

(73) Assignee: American Express Marketing & Development Corp., New York, NY (US)

(21) Appl. No.: 11/214,797

(22) Filed: Aug. 31, 2005

(51) Int. Cl. G06Q 30/00

(52) U.S. Cl. 705/14

(57) ABSTRACT

A system, method, and computer program product are used to control access to promotions is disclosed. The system, method and computer program product control access to promotion information through receiving a partial account number of a cardholder at a customer service system that stores the promotion information, comparing the received partial account number to previously-stored information to produce a verification result, and controlling access to the promotion information based on the verification result. Use of a partial account number (e.g., just the BIN number) allows a card issuer (or their agent) to verify a card holder's eligibility for a promotion, without the need for the card holder to submit and personably-identifiable information.

### BACKGROUND

1. Field of the Invention

The present invention generally relates to allowing customers access to promotions.

2. Related Art

Many consumers receive more unsolicited promotion material than they can process for promotions for which they have no interest. However, even when some of the material is of interest, consumers are reluctant to respond to the solicitations because the solicitations typically require disclosing some personal information just to find out more about the promotion. Thus, even consumers with an interest in the promotions may just ignore the promotions because they do not want to disclose or are sensitive to disclosing personal information. This is especially true when such promotions are being run by third-party partners and not directly by the entity with which the consumer has an exiting relationship. Being deterred from pursuing promotions to avoid disclosing personal information has become a problem even when the promotions are part of a rewards program, meaning the promotions may be free to the consumer if they merely respond to the solicitations.

In some situations, promotions are deemed only for a particular group of consumers because, for example, the promotions are expensive or are in limited supply. More specifically, a card issuer may offer to only to their high-end customers certain distinctive experiences, exclusive partner offers, and the like. Unsolicited consumers, however, may come across information regarding such limited promotions, and try to capitalize on this information. Thus, promotions of this type need to be secured from the general public.

Given the foregoing, what is needed is a system, method and computer program product for controlling access to promotions, while requiring little if any personal information from consumers.

### BRIEF DESCRIPTION

The present invention meets the above-identified needs by providing a system, method and computer program product for controlling access to promotions.

One aspect of the present invention provides a method for controlling access to promotion information comprising receiving a partial account number of a cardholder at a customer service system that stores the promotion information, comparing the received partial account number to previously-stored information to produce a verification result, and controlling access to the promotion information based on the verification result.

Another aspect of the present invention provides a system for controlling access to promotion information comprising an input device, a verification device, and a controller. The input device receives a partial account number. The verification device receives the partial account number from the input device and compares the partial account number to a database of approved partial account numbers to produce a verification result therefrom. The controller allows access to the promotion information or initiates transmission of a message based on the verification result.

A further aspect of the present invention provides a computer program product comprising a computer useable medium having computer program logic recorded thereon for controlling at least one processor. The computer program logic comprises computer program code devices that perform operations similar to the devices in the above embodiment.

Further features and advantages of the present invention as well as the structure and operation of various embodiments of the present invention are described in detail below with reference to the accompanying drawings.

### BRIEF DESCRIPTION OF THE DRAWINGS

The features and advantages of the present invention will become more apparent from the detailed description set forth below when taken in conjunction with the drawings. The left-most digit of a reference number identifies the drawing in which the reference number first appears.

FIG. 1 is a system diagram, according to one embodiment of the present invention.

FIG. 2 is a flowchart depicting a method, according to one embodiment of the present invention.

FIG. 3 is a block diagram of a sample computer system that can be used in the implementation of one or more embodiments of the present invention.

### DETAILED DESCRIPTION

I. Overview and Terminology

The present invention is directed to a system, method and computer program product for controlling access to promotions.

The present invention is now described in more detail herein in terms of an exemplary description. This is for convenience only and is not intended to limit the application of the present invention. In fact, after reading the following description, it will be apparent to one skilled in the relevant art(s) how to implement the following invention in alternative embodiments and environments.

The terms “member,” “card member,” “cardholder,” “user,” “end user”, “consumer”, “customer,” “participant,” etc., and/or the plural form of these terms are used interchangeably throughout herein to refer to those persons or entities capable of accessing, using, be affected by and/or benefiting from the tool that the present invention provides for controlling access to promotions.

Furthermore, the terms “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

Transaction Accounts and Instrument

A “transaction account” as used herein refers to an account associated with an open account or a closed account system (as described below). The transaction account may exist in a physical or non-physical embodiment. For example, a transaction account may be distributed in non-physical embodiments such as an account number, frequent-flyer account, and telephone calling account or the like. Furthermore, a physical embodiment of a transaction account may be distributed as a financial instrument.

A financial transaction instrument may be traditional plastic transaction cards, titanium-containing, or other metal-containing, transaction cards, clear and/or translucent transaction cards, foldable or otherwise unconventionally-sized transaction cards, radio-frequency enabled transaction cards, or other types of transaction cards, such as credit, charge, debit, pre-paid or stored-value cards, or any other like financial transaction instrument. A financial transaction instrument may also have electronic functionality provided by a network of electronic circuitry that is printed or otherwise incorporated onto or within the transaction instrument (and typically referred to as a “smart card”), or be a fob having a transponder and an RFID reader.

Open Versus Closed Cards

“Open cards” are financial transaction cards that are generally accepted at different merchants. Examples of open cards include the American Express®, Visa®, MasterCard® and Discover® cards, which may be used at many different retailers and other businesses. In contrast, “closed cards” are financial transaction cards that may be restricted to use in a particular store, a particular chain of stores or a collection of affiliated stores. One example of a closed card is a pre-paid gift card that may only be purchased at, and only be accepted at, a clothing retailer, such as The Gap® store.

Stored Value Cards

Stored value cards are forms of transaction instruments associated with transaction accounts, wherein the stored value cards provide cash equivalent value that may be used within an existing payment/transaction infrastructure. Stored value cards are frequently referred to as gift, pre-paid or cash cards, in that money is deposited in the account associated with the card before use of the card is allowed. For example, if a customer deposits ten dollars of value into the account associated with the stored value card, the card may only be used for payments up to ten dollars.

Use of Transaction Accounts

With regard to use of a transaction account, users may communicate with merchants in person (e.g., at the box office), telephonically, or electronically (e.g., from a user computer via the Internet). During the interaction, the merchant may offer goods and/or services to the user. The merchant may also offer the user the option of paying for the goods and/or services using any number of available transaction accounts. Furthermore, the transaction accounts may be used by the merchant as a form of identification of the user. The merchant may have a computing unit implemented in the form of a computer-server, although other implementations are possible.

In general, transaction accounts may be used for transactions between the user and merchant through any suitable communication means, such as, for example, a telephone network, intranet, the global, public Internet, a point of interaction device (e.g., a point of sale (POS) device, personal digital assistant (PDA), mobile telephone, kiosk, etc.), online communications, off-line communications, wireless communications, and/or the like.

Account and Merchant Numbers

An “account,” “account number” or “account code”, as used herein, may include any device, code, number, letter, symbol, digital certificate, smart chip, digital signal, analog signal, biometric or other identifier/indicia suitably configured to allow a consumer to access, interact with or communicate with a financial transaction system. The account number may optionally be located on or associated with any financial transaction instrument (e.g., rewards, charge, credit, debit, prepaid, telephone, embossed, smart, magnetic stripe, bar code, transponder or radio frequency card).

The account number may be distributed and stored in any form of plastic, electronic, magnetic, radio frequency (RF), wireless, audio and/or optical device capable of transmitting or downloading data from itself to a second device. A customer account number may be, for example, a sixteen-digit credit card number. Each credit card issuer has its own numbering system, such as the fifteen-digit numbering system used by American Express Company of New York, N.Y. Each issuer's credit card numbers comply with that company's standardized format such that an issuer using a sixteen-digit format will generally use four spaced sets of numbers in the form of:

N₁N₂N₃N₄ N₅N₆N₇N₈ N₉N₁₀N₁₁N₁₂ N₁₂N₁₄N₁₅N₁₆

The first five to seven digits are reserved for processing purposes and identify the issuing institution, card type, etc. In this example, the last (sixteenth) digit is typically used as a sum check for the sixteen-digit number. The intermediary eight-to-ten digits are used to uniquely identify the customer, card holder or card member.

A merchant account number may be, for example, any number or alpha-numeric characters that identifies a particular merchant for purposes of card acceptance, account reconciliation, reporting and the like.

RFID and Transmission of Magnetic Stripe Data

It should be noted that the transfer of information in accordance with the present invention, may be done in a format recognizable by a merchant system or account issuer. In that regard, by way of example, the information may be transmitted from an RFID device to an RFID reader, or from the RFID reader to the merchant system in magnetic stripe or multi-track magnetic stripe format.

Because of the proliferation of devices using magnetic stripe format, the standards for coding information in magnetic stripe format were standardized by the International Organization for Standardization in ISO/IEC 7811-n (characteristics for identification cards) which are incorporated herein by reference. The ISO/IEC 7811 standards specify the conditions for conformance, physical characteristics for the card (warpage and surface distortions) and the magnetic stripe area (location, height and surface profile, roughness, adhesion, wear and resistance to chemicals), the signal amplitude performance characteristics of the magnetic stripe, the encoding specification including technique (MFM), angle of recording, bit density, flux transition spacing variation and signal amplitude, the data structure including track format, use of error correction techniques, user data capacity for ID-1, ID-2 and ID-3 size cards, and decoding techniques, and the location of encoded tracks.

Typically, magnetic stripe information is formatted in three tracks. Certain industry information must be maintained on certain portion of the tracks, while other portions of the tracks may have open data fields. The contents of each track and the formatting of the information provided to each track is controlled by the ISO/IEC 7811 standard. For example, the information must typically be encoded in binary. Track 1 is usually encoded with user information (i.e., name) in alphanumeric format. Track 2 is typically comprised of discretionary and nondiscretionary data fields. In one example, the nondiscretionary field may comprise 19 characters and the discretionary field may comprise 13 characters. Track 3 is typically reserved for financial transactions and includes enciphered versions of the user's personal identification number, country code, current units amount authorized per cycle, subsidiary accounts, and restrictions.

As such, where information is provided in accordance with the present invention, it may be provided in magnetic stripe track format. For example, the counter values, authentication tags and encrypted identifiers, described herein, may be forwarded encoded in all or a portion of a data stream representing data encoded in, for example, track 2 or track 3 format.

System Overview

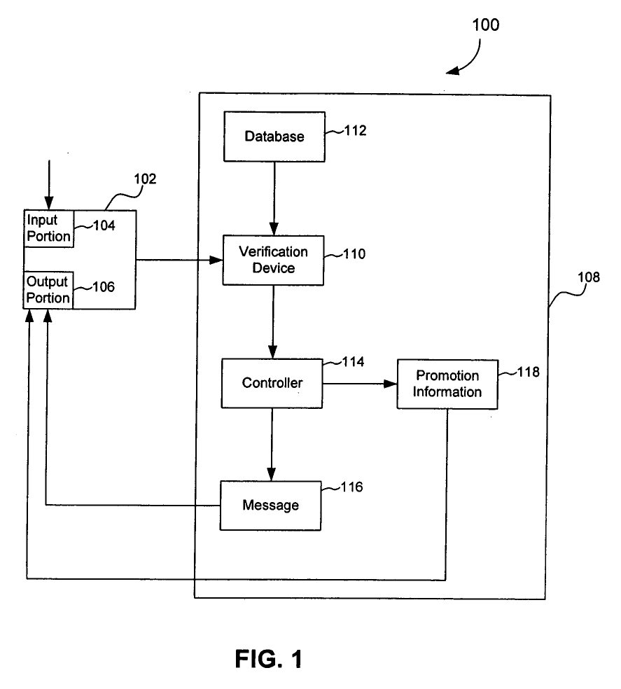

FIG. 1 shows a system 100, according to one embodiment of the present invention. System 100 includes a consumer communication device 102 that includes at least an input portion 104 and an output portion 106. In one embodiment, communications device 102 is a telephonic device of a consumer, for example a wired or wireless telephone, a personal data assistant (PDA) with telephonic functionality, or the like. In this embodiment, input portion 104 can be, but is not limited to, a keypad, a graphical user interface, or the like, which allows for entry of a partial account number of an account of the consumer. The account can be associated with any financial instrument or transaction account. In one embodiment, when a consumer is responding to a solicitation for a promotion, the partial account number can be entered and forward to a customer service system 108 for verification of whether the consumer falls within one or more groups of consumers (e.g., card members) allowed to access the promotion, as is described in more detail below. The information can be forwarded via any known network using either analog, digital, or other types of signals supported by the network. In such an embodiment, output portion 106 allows for output to the consumer, such as display devices, a speaker, or the like.

Customer service system 108 includes a verification device 110, a database 112, a controller 114, a message portion 116, and a promotion information portion 118. In alternate embodiments, as will be appreciated by those skilled in the relevant art(s) after reading the description herein, the system 108 portion of system 100 may be owned and/or operated by the card issuer itself or a third-party fulfillment entity acting as an agent for the card issuer.

In another embodiment, communications device 102 is a computer system, or the like. In such an embodiment, input device 104 is a keyboard, voice receiver, mouse, a graphical user interface, a touch screen of a graphical user interface, or the like, that allows for receiving of a partial account number from the consumer. This information is forwarded to customer service system 108 via a wired or wireless network, such as an intranet or the public Internet, using either normal (e.g., HTTP) or secure (e.g., HTTPS) transmissions.

In one embodiment, the partial account number can be a portion of an account number assigned to a card company, but which is not specifically linked to any personal data of the consumer. In such an embodiment, the Bank Identification Number (BIN) is used as the partial account number—which, in an embodiment, can be the first six digits of a credit card, debit card, charge card, etc. account number. These digits identify which network the card belongs to as well as which bank issued it, but contain no personably identifiable information. Rather, it is the other numbers in the account number that are assigned to individual consumers by an issuing bank or other institution that receives these cards from the card company and then issues the cards to consumers. That is, it is the remaining numbers in the account number that (securely) stores associations between those numbers and personal information of the consumer. In alternate embodiments, as will be appreciated by those skilled in the relevant art(s) after reading the description herein, the partial account number can be the entire BIN, a portion of the BIN, or any other partial combination of the account number.

Thus, the partial account number input into communications device 102 and transmitted to customer service system 108 may not include any association with any personal information of the consumer, only a status/type of the card held by the consumer. This can be used for promotions that are limited to certain status of cards without a need to know any personal information of a person holding the card. Thus, the person is less hesitant to respond to the solicitation because they know they have little or no risk of having their personal information released (or misused by fraudsters).

In one example, verification device 110 receives the partial account number and compares it to numbers stored in database 112. In one example, the verification may involve a one-to-one comparison to see if the exact number is located within an approved list in the database. In another example, the verification may involve a comparison to a high and a comparison to a low number to see if the received partial account number falls within an approved range of numbers between the high and low number. Other criteria can also be used, as would be apparent to one of ordinary skill in the art. A verification result is forwarded from verification device 110 to controller 114. Based on this verification result, controller 114 determines whether the verification was successful (e.g., there is a comparison match or the inputted partial account number is within a predefined range) or unsuccessful (e.g., there is not a comparison match or the inputted partial account number is not within a predefined range).

If unsuccessful, controller 114 initiates forwarding of a message (e.g., a prerecorded message for a telephonic system or a text or graphical message for a computer system, or the like) to communications device 102, which may be conveyed to the consumer via output portion 106. This message may be a “hard” message of rejection, or a “soft” message of try again later. For example, when using “soft” message in the computer system environment, a web page can instruct the consumer to try again later or that the system is down, instead of displaying an outright rejection of the partial account number.

If successful, controller 114 connects communication device 104 to promotion information 118. In one embodiment, when verification is successful in a telephonic environment, controller 114 can connect the consumer to a consumer service representative (i.e., promotion information 118) via communications device 102. Such consumer service representative would then discuss the promotion with the consumer.

In another embodiment, when the verification is successful in a computer system environment, promotion information 118 is located in a memory that is accessed via one or more web pages that are displayed to the consumer via output portion 106. These web pages are only accessible to a consumer whose partial account number was verified as allowing them to see the one or more web pages.

In one embodiment, promotion information 118 can be related to experiences, for example, but not limited to, personal chefs, hot air balloon rides, race car driving, cruises, cattle drives, safaris, etc. In alternate embodiment, promotion information 118 can be related to offers, for example, but not limited to, merchandise, services, airline upgrades, free travel tickets, etc.

Overview of Operation

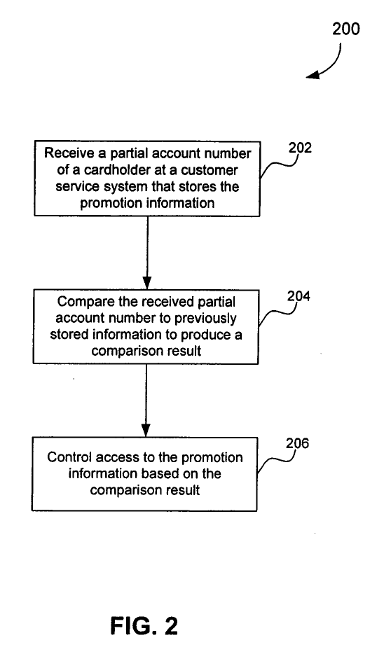

FIG. 2 shows a flowchart depicting a method 200, according to one embodiment of the present invention. For example, method 200 can be performed to control access to promotion information using system 100 described above.

In step 202, a partial account number (e.g., a BIN number) of a cardholder is received at a customer service system that stores the promotion information. In one example, this is done using a telephonic system to transmit and receive the partial account number. In this example, the partial account number is input via a number entering portion of a telephonic device. In another example, this is done using a network to transmit and receive the partial account number. In this example, the partial account number is input via a computer input device (e.g., a key board, a touch screen, a mouse, via a graphical user interface, or the like).

In step 204, the received partial account number is compared to previously-stored information to produce a verification result (e.g., a comparison result). In one embodiment, the stored information comprises partial account numbers associated with a predetermined membership level of a card and a one-to-one comparison is made. For example, for a specific promotion, only card members having a specific type of card (e.g., standard, gold, platinum, etc.) or having a specific status (e.g., mileage level, etc.) may qualify (as predetermined by the card issuer, or the like, and communicated to, and stored at, system 108). In another embodiment, a determination is made whether the partial account number falls within an approved range set by an upper end and lower end number. Other comparison methods could also be used, as would be apparent to a skilled artisan upon reading this description.

In step 206, access to the promotion information is controlled based on the verification result. In a telephonic environment, step 206 can be achieved by connecting the cardholder to a customer service representative or to an interactive voice response system if the verification step is successful, or transmitting a message to the cardholder if the verification step is unsuccessful. In the computer system environment, step 206 can be achieved by linking the cardholder to a promotion information web page if the verification step is successful and displaying a message to the cardholder on a current web page if the verification step is unsuccessful.

### EXAMPLE IMPLEMENTATIONS

The present invention (i.e., system 100, method 200, or any part(s) or function(s) thereof) may be implemented using hardware, software or a combination thereof and may be implemented in one or more computer systems or other processing systems. However, the manipulations performed by the present invention were often referred to in terms, such as receiving or comparing, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices.

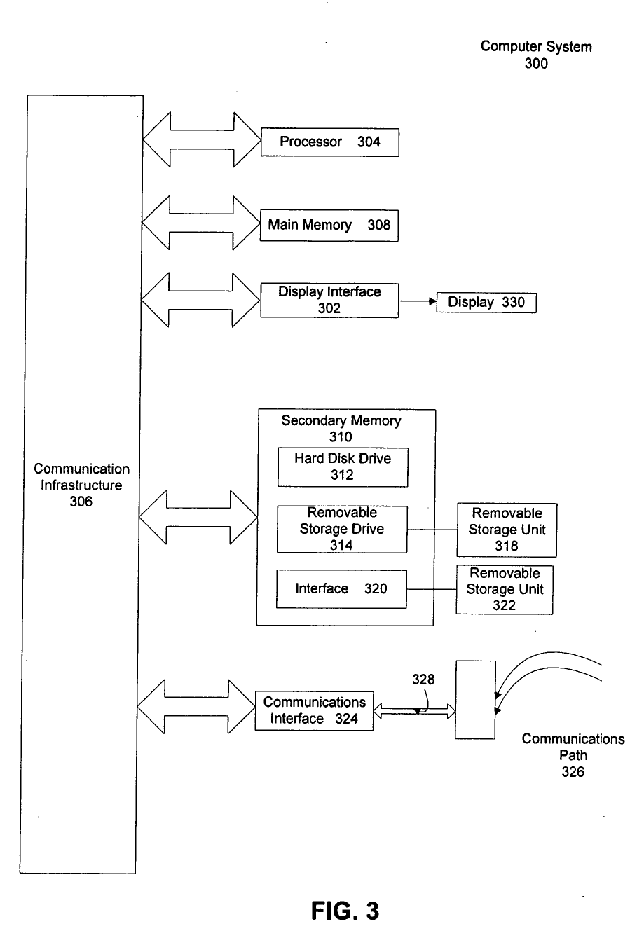

In fact, in one embodiment, the invention is directed toward one or more computer systems capable of carrying out the functionality described herein. An example of a computer system 300 is shown in FIG. 3.

The computer system 300 includes one or more processors, such as processor 304. The processor 304 is connected to a communication infrastructure 306 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 300 can include a display interface 302 that forwards graphics, text, and other data from the communication infrastructure 306 (or from a frame buffer not shown) for display on the display unit 330.

Computer system 300 also includes a main memory 308, preferably random access memory (RAM), and may also include a secondary memory 310. The secondary memory 310 may include, for example, a hard disk drive 312 and/or a removable storage drive 314, representing a floppy disk drive, a magnetic tape drive, an optical disk drive, etc. The removable storage drive 314 reads from and/or writes to a removable storage unit 318 in a well known manner. Removable storage unit 318 represents a floppy disk, magnetic tape, optical disk, etc. which is read by and written to by removable storage drive 314. As will be appreciated, the removable storage unit 318 includes a computer usable storage medium having stored therein computer software and/or data.

In alternative embodiments, secondary memory 310 may include other similar devices for allowing computer programs or other instructions to be loaded into computer system 300. Such devices may include, for example, a removable storage unit 322 and an interface 320. Examples of such may include a program cartridge and cartridge interface (such as that found in video game devices), a removable memory chip (such as an erasable programmable read only memory (EPROM), or programmable read only memory (PROM)) and associated socket, and other removable storage units 322 and interfaces 320, which allow software and data to be transferred from the removable storage unit 322 to computer system 300.

Computer system 300 may also include a communications interface 324. Communications interface 324 allows software and data to be transferred between computer system 300 and external devices. Examples of communications interface 324 may include a modem, a network interface (such as an Ethernet card), a communications port, a Personal Computer Memory Card International Association (PCMCIA) slot and card, etc. Software and data transferred via communications interface 324 are in the form of signals 328 which may be electronic, electromagnetic, optical or other signals capable of being received by communications interface 324. These signals 328 are provided to communications interface 324 via a communications path (e.g., channel) 326. This channel 326 carries signals 328 and may be implemented using wire or cable, fiber optics, a telephone line, a cellular link, an radio frequency (RF) link and other communications channels.

In this document, the terms “computer program medium” and “computer usable medium” are used to generally refer to media such as removable storage drive 314, a hard disk installed in hard disk drive 312, and signals 328. These computer program products provide software to computer system 300. The invention is directed to such computer program products.

Computer programs (also referred to as computer control logic) are stored in main memory 308 and/or secondary memory 310. Computer programs may also be received via communications interface 324. Such computer programs, when executed, enable the computer system 300 to perform the features of the present invention, as discussed herein. In particular, the computer programs, when executed, enable the processor 304 to perform the features of the present invention. Accordingly, such computer programs represent controllers of the computer system 300.

In an embodiment where the invention is implemented using software, the software may be stored in a computer program product and loaded into computer system 300 using removable storage drive 314, hard drive 312 or communications interface 324. The control logic (software), when executed by the processor 304, causes the processor 304 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s). In yet another embodiment, the invention is implemented using a combination of both hardware and software.

Conclusion

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention ). Thus, the present invention should not be limited by any of the above described exemplary embodiments, but should be defined only in accordance with the following claims and their equivalents.

In addition, it should be understood that the figures and/or screen shots illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the following Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A method for controlling access of a cardholder to promotion information, comprising:
(a) receiving a partial account number of the cardholder at a customer service system that stores the promotion information;
(b) comparing the received partial account number to previously-stored information to produce a verification result; and
(c) controlling access to the promotion information based on the verification result;
wherein the partial account number is not personably-identifiable information.

2. The method of claim 1, wherein step (a) comprises:
using a cardholder first portion of a telephonic system to transmit the received partial account number and a second portion of the telephonic system to perform the receiving step.

3. The method of claim 2, wherein step (c) comprises:
connecting the cardholder to a customer service representative if step (b) is successful; and
transmitting a message to the cardholder if step (b) is unsuccessful.

4. The method of claim 2, wherein the partial account number is input via a telephonic device.

5. The method of claim 1, wherein step (a) comprises:
using a network to receive the partial account number.

6. The method of claim 5, wherein the partial account number is input via a computer input device.

7. The method of claim 5, wherein step. (c) comprises:
providing the cardholder with access to the promotion information if step (b) is successful; and
denying the cardholder access to the promotional information if step (b) is unsuccessful.

8. The method of claim 1, further comprising using the BIN number portion of an account number as the partial account number.

9. The method of claim 1, wherein the stored information comprises a range of partial account numbers associated with a predetermined card membership level.

10. The method of claim 1, further comprising using a portion of the account number designating a card membership level as the partial account number.

11. The method of claim 1, wherein the promotion information includes at least one of: experience promotion information; and offer promotion information.

12. A system for controlling access to promotion information, comprising:
an input device that receives a partial account number;
a verification device that receives the partial account number from the input device and compares the partial account number to a database of approved partial account numbers to produce a verification result therefrom; and
a controller capable of allowing access to the promotion information and initiating transmission of a message, based on the verification result.

13. The system of claim 12, wherein the input device is a telephonic device.

14. The system of claim 13, wherein the controller allows access to the promotion information by connecting the telephonic device to a customer service system if the verification is successful.

15. The system of claim 13, wherein the controller initiates the transmission of the message by connecting the telephonic device to a prerecorded message system in order to indicate the verification was unsuccessful.

16. The system of claim 12, wherein the input device is an input portion of a computer system.

17. The system of claim 16, wherein the controller allows access to the promotion information by connecting the computer system to a promotion information web page from a partial account number input web page if the verification was successful.

18. The system of claim 16, wherein the message is displayed on a partial account number input web page and indicates the verification was unsuccessful.

19. A computer program product for controlling access to promotion information, the computer program product comprising a computer usable medium having control logic stored therein, said control logic comprising:
first computer readable program code means for receiving a partial account number of a cardholder at a customer service system that stores the promotion information;
second computer readable program code means for comparing the received partial account number to previously-stored information to produce a verification result; and
third computer readable program code means for controlling access to the promotion information based on the verification result.
